(19) United States
(12) Patent Application Publication
(10) Pub. No.: US 2025/0012339 A1
(43) Pub. Date: Jan. 9, 2025

(54) FASTENING SYSTEM FOR A CONVEYOR BELT

(71) Applicant: Laitram, L.L.C., Harahan, LA (US)

(72) Inventors: Michael Hendrik DeGroot, Rockford, MI (US); Gabriel Nazar, New Orleans, LA (US); James R. Honeycutt, Jr., Grandville, MI (US); Jeff Batchelder, Hesperia, MI (US); Gerko Hulshof, Aalten (NL); Martin Sprenkeler, Enschede (NL); Khoi Vu, Zwolle (NL)

(21) Appl. No.: 18/709,887

(22) PCT Filed: Nov. 23, 2022
(86) PCT No.: PCT/US2022/050856

§ 371 Date: May 14, 2024

Related U.S. Application Data
(60) Provisional application No. 63/282,260, filed on Nov. 23, 2021.

(51) Int. Cl. F16G 3/04

(52) U.S. Cl. CPC F16G 3/04

(57) ABSTRACT

A fastening system for joining two opposing ends of flexible conveyor belt segments includes mating sets of rigid connectors embedded in and extending from confronting ends of the flexible conveyor belt segments. The rigid connectors include laterally-extending load-transferring surfaces that interface to transmit axial tension between the confronting segment ends, or hinge elements that interleave to form a hinge passageway for receiving a connecting rod. The rigid connectors are chemically bonded to the conveyor belt segment ends through microscopic entanglement, a mechanical bond, adhesive bond or through another suitable process.

### RELATED APPLICATIONS

The present application claims priority to U.S. Provisional Patent Application No. 63/282,260, filed Nov. 23, 2021 and entitled “Fastening System for a Conveyor Belt” the contents of which are herein incorporated by reference.

### BACKGROUND

The present invention relates generally to power-driven conveyor belts, and more particularly, to a system and method for connecting ends of a conveyor belt body to form an endless conveyor belt.

Low tension, direct drive conveyor belts are typically used in situations where hygiene and cleanliness are important. For example, in food processing plants such as those that process meat products for human consumption, low tension, direct drive conveyor belts are used to transport items. Sanitation is important and, therefore, the endless belts used in such conveyors are conventionally made of materials that can be hygienically cleaned, such as thermoplastics or stainless steel.

An example of a flexible endless belt suitable for implementing an illustrative embodiment of the invention is shown in FIG. 1. An endless conveyor belt 10 in a typical installation moves around two sprockets 12 and 14, drums or pulleys. A first sprocket 12 may be a drive sprocket for driving the conveyor belt, while the second sprocket may be an idle or slave sprocket 14. The belt 10 has an outer surface 110 serving as an article-conveying surface and an inner surface 112 serving as a drive surface. The inner surface 112 includes drive elements, illustrated as teeth 26, preferably spaced equidistantly from each other along the inner driven surface 22. The teeth 26 engage grooves 16, or other suitable structure, spaced around the circumference of the sprockets 12, 14 to move the belt. The upper span of the belt will travel in the direction of arrow 15. The flexible belt 10 wraps around the sprocket and around a return roller, or shoe or drum, in the return path.

The belt is made of a resilient material, such as a thermoplastic polymer, an elastomer, or a rubber, and is flexible along its length. Examples of such flexible endless belts include the THERMODRIVE series of belts available from Intralox, L.L.C. of Harahan, LA, the SuperDrive™ and other positive drive belts available from Volta Belting Technology, the Cleandrive product line available from Habasit and other flexible, positive drive conveyor belts known in the art.

A flexible endless belt is normally formed by joining two ends of the belt together at a seam 120. Methods of joining two ends of the belts together include splicing, whereby splicing presses are used to weld the butt ends of the conveyor belt sections together, mechanical means, such as a hinge-pin system and/or a knuckled connector system described in U.S. Pat. Nos. 8,002,110 and 8,695,790, the contents of which are incorporated herein by reference.

The belt may have to be removed from the sprockets for maintenance of the system, for cleaning, or for repair. Removing the endless belt 10 of FIG. 1 poses an inconvenience, normally requiring disassembly of the conveyor frame, movement of the sprockets, and possibly destruction of the belt (or at least cutting the belt to be re-seamed later).

### SUMMARY

The present invention provides a fastening system for a flexible conveyor belt. The fastening system includes mating sets of rigid connectors embedded in and extending from confronting ends of the flexible conveyor belt. The rigid connectors include laterally-extending load-transferring surfaces that interface to transmit axial tension between the belt ends. Alternatively, the rigid connectors comprise hinge elements that interleave to form a hinge passageway for receiving a connecting rod. The rigid connectors are chemically, mechanically or otherwise bonded to the conveyor belt ends through microscopic entanglement or another suitable process.

According to one aspect, a fastening system for fastening a first end of a flexible conveyor belt segment to a second end of a flexible conveyor belt segment, comprises a first rigid connector extending from the first end and a second rigid connector extending from the second end. The first rigid connector comprises a base embedded in the first end and a connecting portion. The connecting portion includes a first laterally-extending load-transferring surface. The second rigid connector comprises a base embedded in the second end and a connecting portion comprising a second laterally-extending load-transferring surface configured to interface with the first laterally-extending load-transferring surface.

According to another aspect, a conveyor belt segment comprises a flexible body extending in thickness from a top surface to a bottom surface, in width from a first side to a second side and in length from a first end to a second end and a first rigid connector extending from the first end. The first rigid connector comprises a base embedded in the flexible body and a connecting portion protruding from the first end.

According to another aspect, a conveyor belt segment configured to mate with another conveyor belt segment is provided. The conveyor belt segment comprises a flexible body having a top conveying surface and a bottom surface including drive structure. The flexible body extends in length from a first end to a second end and in width from a first side to a second side. A first set of laterally spaced apart rigid connectors extends from the first end of the flexible body. Each rigid connector includes a base embedded in the flexible body through microscopic entanglement and a connecting portion extending from the first end.

### BRIEF DESCRIPTION OF THE DRAWINGS

These features of the invention, as well as its advantages, are better understood by referring the following description, appended claims, and accompanying drawings, in which:

FIG. 1 illustrates an endless conveyor belt of the prior art;

FIG. 2 is an isometric top view of a fastening system for an endless conveyor belt according to an embodiment;

FIG. 3 is a bottom view of the fastening system of FIG. 2;

FIG. 4 is an exploded top view of the fastening system of FIG. 2;

FIG. 5 is an exploded side view of the fastening system of FIG. 2;

FIG. 6 is an isometric top view of a rigid hooking connector of the fastening system of FIG. 2;

FIG. 7 is an isometric bottom view of the rigid hooking connector of FIG. 6;

FIG. 8 is an isometric top view of a rigid eyelet connector configured to mate with the rigid hooking connector of FIG. 6;

FIG. 9 is an isometric bottom view of the rigid eyelet connector of FIG. 9;

FIG. 10 shows the rigid hooking connector of FIG. 6 prior to insertion in the rigid eyelet connector of FIG. 8;

FIG. 11 shows the rigid hooking connector of FIG. 6 engaged with the rigid eyelet connector of FIG. 8;

FIG. 12 is an isometric view of a conveyor belt segment including a series of laterally-spaced apart rigid eyelet connectors embedded therein;

FIG. 13 is an isometric view of a conveyor belt segment including a series of laterally-spaced apart rigid hooking connectors embedded therein;

FIG. 14 is a side view of the fastening system of FIG. 2 during alignment of the mating components;

FIG. 15 is a side view of the fastening system of FIG. 2 during insertion of the hooks into the eyelets;

FIG. 16 is a side view of the fastening system of FIG. 2 while the hooks and eyelets are in an engaged position;

FIG. 17 is a side view of the fastening system of FIG. 2 with a locking rod in place;

FIG. 18 is a detailed view of an end portion of the fastening system of FIG. 2;

FIG. 19 is a cross-sectional view through line A-A of FIG. 18;

FIG. 20 is an isometric top view of a fastening system for an endless conveyor belt according to another embodiment;

FIG. 21 is an exploded top view of the fastening system of FIG. 20;

FIG. 22 is an exploded bottom view of the fastening system of FIG. 20;

FIG. 23 is an isometric view of rigid eyelet connector of the fastening system of FIG. 20;

FIG. 24 is an isometric view of a rigid hooking connector of the fastening system of FIG. 20;

FIG. 25 shows the rigid eyelet connector of FIG. 23 engaged with the rigid hooking connector of FIG. 24;

FIG. 26 is an isometric bottom view of the fastening system of FIG. 20 prior to mating;

FIG. 27 is an isometric bottom view of the fastening system of FIG. 20 during mating;

FIG. 28 is a top view of an edge portion of the fastening system of FIG. 20 in an engaged position;

FIG. 29 is a cross-sectional view through line A-A of FIG. 28;

FIG. 30 is an isometric top view of a fastening system for a flexible conveyor belt according to another embodiment;

FIG. 31 is an isometric bottom view of the fastening system of FIG. 30;

FIG. 32 is an isometric top view of a rigid male connector of the fastening system of FIG. 30;

FIG. 33 is an isometric bottom view of the rigid male connector of FIG. 32;

FIG. 34 is an isometric top view of a rigid female connector of the fastening system of FIG. 30.

FIG. 35 is an isometric bottom view of the rigid female connector of FIG. 34;

FIG. 36 shows the rigid male connector of FIG. 32 during mating with the rigid female connector of FIG. 34;

FIG. 37 is an isometric top view of the fastening system of FIG. 30 during insertion of the male connectors into the female connectors;

FIG. 38 is a top view of the fastening system of FIG. 30 during insertion of a locking rod;

FIG. 39 is a detailed edge view of the fastening system of FIG. 30;

FIG. 40 is a cross-sectional view through line A-A of FIG. 39;

FIG. 41 is an isometric bottom view of a fastening system for a flexible conveyor belt according to another embodiment;

FIG. 42 is a detailed bottom view of an edge of the fastening system of FIG. 41 prior to mating;

FIG. 43 shows the edge of FIG. 42 during mating;

FIG. 44 is a top view of the edge of FIG. 42 during mating;

FIG. 45 is a bottom view of the edge of FIG. 42 in a mated position;

FIG. 46 is a bottom view of a first set of rigid mating connectors of the fastening system of FIG. 41 in a fastened position;

FIG. 47 is a bottom view of a first rigid connector of the first set of rigid mating connectors of FIG. 46;

FIG. 48 is a top view of the first rigid connector of FIG. 47;

FIG. 49 is a bottom view of a second rigid connector of the fastening system of FIG. 41

FIG. 50 is an isometric view of the second rigid connector of FIG. 49;

FIG. 51 is a bottom view of a second set of rigid mating connectors of the fastening system of FIG. 41 in a mating position;

FIG. 52 is a bottom view of a third rigid connector in the second set of rigid mating connectors of FIG. 51;

FIG. 53 is an isometric view of a fourth rigid connector in the second set of rigid mating connectors of FIG. 51;

FIG. 54 is a bottom view of the fourth rigid connector of FIG. 53;

FIG. 55 is another embodiment of the fourth rigid connector of FIG. 53;

FIG. 56 is a top isometric view of a fastening system for a flexible conveyor belt according to another embodiment;

FIG. 57 is an exploded view of the fastening system of FIG. 56;

FIG. 58 is a bottom exploded view of the fastening system of FIG. 56;

FIG. 59 is a top view of a set of rigid connectors of the fastening system of FIG. 56;

FIG. 60 is a bottom view of the set of rigid connectors of FIG. 59.

### DETAILED DESCRIPTION

The present invention provides a fastening system for facilitating assembly and disassembly of a conveyor belt. The present invention will be described below relative to an illustrative embodiment. Those skilled in the art will appreciate that the present invention may be implemented in a number of different applications and embodiments and is not specifically limited in its application to the particular embodiments depicted herein.

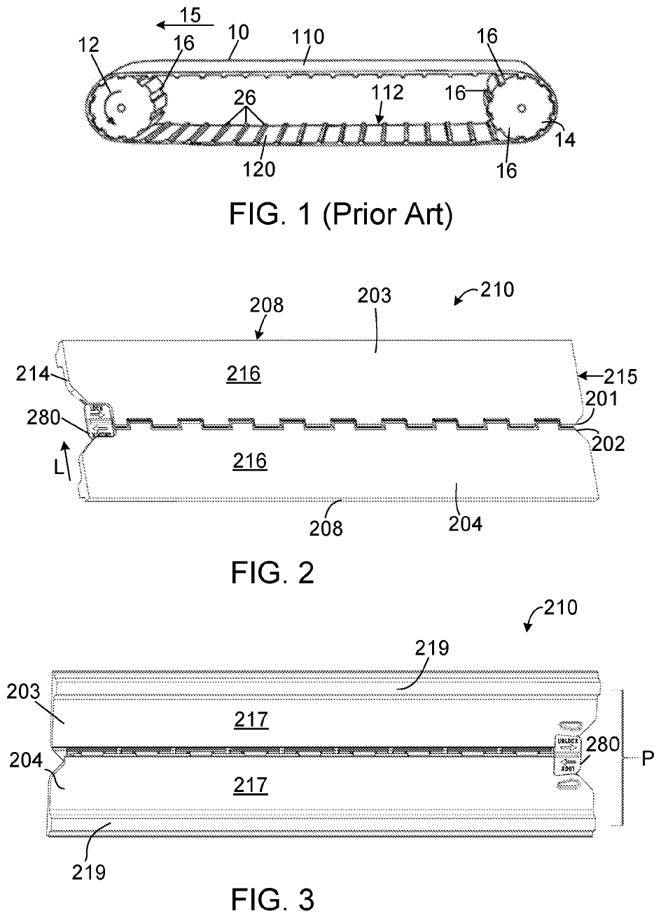

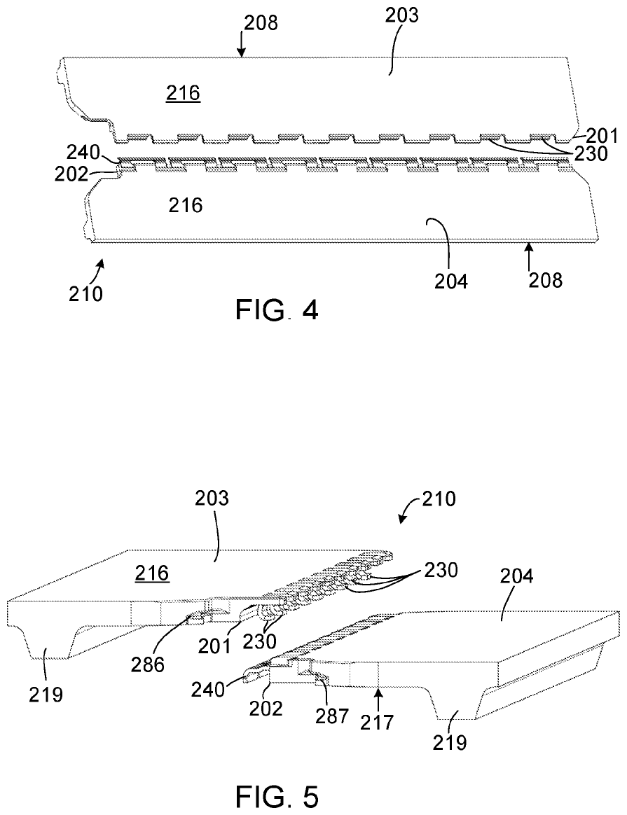

FIGS. 2-5 illustrate a fastening 210 for a conveyor belt according to an illustrative embodiment of the invention. The fastening system fastens two ends 201, 202 of one or more belt segments 203, 204 together at a seam to form an endless conveyor belt or a portion of an endless conveyor belt. The fastening system may fasten the ends of a single, elongated belt segment to form an endless conveyor belt, or fasten successive segments together. Each illustrative belt segment 203, 204 comprises a flexible belt body that extends longitudinally from the mating end 201, 202 to an opposite second end 208 and laterally from a first side 214 to a second side 215. The body of each belt segment 203 extends in thickness from an outer surface 216, illustrated as a conveying surface for conveying a product, to an inner surface 217. The inner surface may be a drive surface including drive elements, illustrated as teeth 219, extending therefrom. The drive elements engage sprockets, such as the sprocket 12 shown in FIG. 1, or drums that drive or guide the conveyor belt. The longitudinal direction L is the direction of belt travel when a conveyor belt comprising the fastening system 210 is implemented in a conveyor system. As shown, the teeth 219 are spaced longitudinally on the inner surface 217 by a distance P, defined as a belt pitch. Other suitable driving means may be used, and the invention is not limited to drive teeth that engage a sprocket.

An endless conveyor belt may comprise a plurality of belt segments joined together, in which case the outer ends 208 are themselves fastened to another belt segment, or a single belt segment having ends joined together using the fastening system 210 to form an endless belt.

The conveyor belt segments 203, 204 and resulting conveyor belt can be formed of any suitable material, such as a thermoplastic polymer, an elastomer, or a rubber, and is preferably flexible about both longitudinally and laterally, so that the resulting conveyor belt is capable of forming a trough. The conveyor belt can be made from any of a number of methods, e.g., milling, extrusion, and/or injection molding.

The illustrative conveyor belt fastening system 210 includes a first set of laterally spaced apart rigid connectors 230 extending from the inner end 201 of a belt segment 203. The first set of rigid connectors 230 is arranged to mate with a second set of laterally spaced apart rigid connectors 240 extending from the inner end 202 of the opposing belt segment 204 to join the belt segment ends together.

The rigid connectors 230, 240 are anchored in the flexible belt segments 203, 204 with the mating portions extending from the corresponding ends of the flexible belt segments. In one embodiment, the rigid connectors 230, 240 are anchored within the body of the flexible belt segments through a process called “microscopic entanglement.” In such a process, a polymer brush is applied to certain adhering surfaces on the rigid material to prime the adhering surfaces for bonding with the material in the flexible belt segment. Then, the flexible belt segments 203, 204 are formed by inserting rigid connectors 230 or 240 into an injection mold and injection molding the flexible belt segments such that the flexible material bonds to the polymer brushes on the adhering surfaces, causing the rigid connectors 230, 240 to be embedded in the flexible belt segment, with connecting portions of the rigid connectors 230, 240 protruding from the ends of the flexible belt segments. This process may result in a chemical bond in addition to or in lieu of a bond made through microscopic entanglement. A suitable process for bonding the rigid connectors to the flexible belt segments is the thermoplastic adhesion technology available from Radisurf ApS of Risskov, Denmark. A description of the process for forming the polymer brushes to allow bonding of the rigid connectors to the flexible belt segments can be found in U.S. patent application No. 20210047456, entitled “Compositions for Forming Polymer Brushes”, the contents of which are herein incorporated by reference. However, other suitable means for adhering the rigid connectors to the flexible belt segments may be used. For example, in another embodiment, the material in the flexible belt segment can be melted, then pressed against the rigid connector(s) after the rigid connector has been treated with polymer brushes, to adhere the rigid connector(s) to the flexible belt segment. In another embodiment, an adhesive may be used to bond rigid connector(s) to the flexible belt segment, or a mechanical or other type of chemical bond may be used.

In another embodiment, the rigid connectors 230, 240 are embedded or otherwise attached to the flexible belt segments through an adhesive, mechanical bond or other suitable means.

In one embodiment, the first set of rigid connectors 230 comprises a series of hooks configured to be received in corresponding eyelets on the second set of rigid connectors 240.

A locking rod 280 may be inserted through a passageway formed by the interconnected rigid connectors 230, 240 to further secure the connection, but the invention is not so limited. Locking recesses 286, 287 may be formed in the side edges of the conveyor belt segments 203, 204 for seating edges of the locking rod.

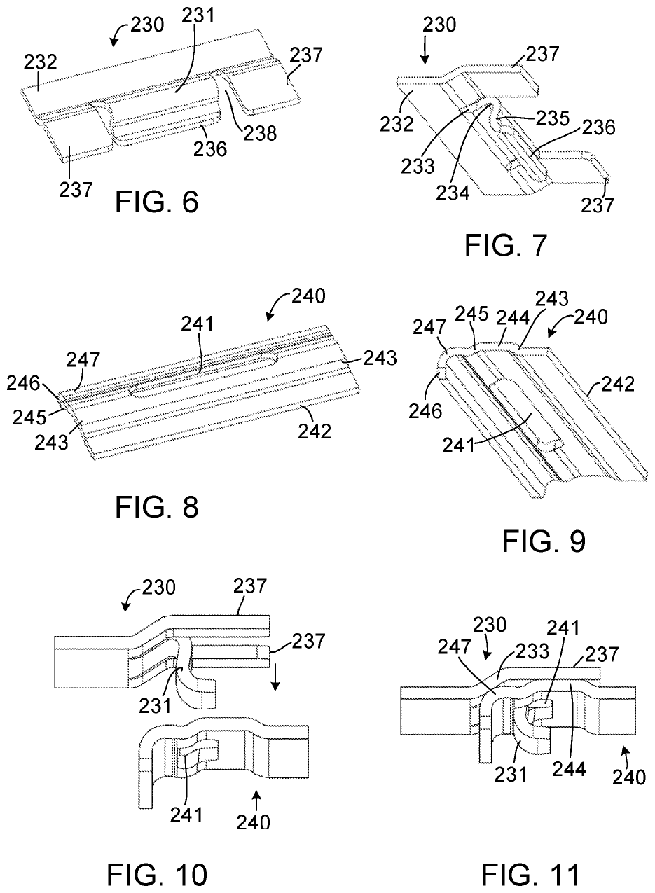

Referring to FIGS. 6-7, the first rigid connectors, shown as hooking connectors 230, each comprises a base portion 232 configured to be embedded in the body of a conveyor belt segment. The illustrative base portion 232 is planar, but the invention is not so limited. A hooking portion extends from the base portion 232 and extends from the end 201 of the conveyor belt segment 203. The hooking portion comprises a downward extending hook 231 comprising a first upward extending intermediate portion 233 extending from the base portion 232, an upper curve 234, a downward-extending straight portion 235 forming a load-transferring surface and a curved tip 236 extending away from the base portion 232. Fingers 237 extend outward from the upward extending intermediate portion 233 and are separated from the hook 231 by spaces 238. The illustrative fingers 237 are parallel to, but higher than, the base portion 232.

Referring to FIGS. 8 and 9, the second rigid connectors 240, forming eyelets, each comprises a base portion 242 configured to be embedded in the body of a conveyor belt segment. The illustrative base portion 242 is planar, but the invention is not so limited. An eyelet portion includes an opening forming an eyelet 241 configured to receive the hook 231 of a first rigid connector. The eyelet portion comprises an upward slanted portion 243, a horizontal planar portion 244 that is parallel to, but higher than, the base portion 242, and a downward slanted portion 245 extending away from the base portion 242, with the eyelet 241 formed in the horizontal planar portion 244 and downward slanted portion 245. The end of the connector 240 transitions to a downward extending segment 246 via curved transition portion 247.

The rigid connectors 230, 240 may be formed of any suitable rigid material. Examples include, but are not limited to stainless steel, titanium, and other metals, glass fiber, carbon fiber, a rigid plastic, such as Nylon 6-6, polyproylene, polystyrene, polycarbonate, PEEK, methacrylate and others known in the art, and combinations thereof, through any suitable manufacturing method.

The illustrative first set of rigid connectors 230 comprises a series of rigid connectors 230, each with a hook 231, separately formed and embedded within the belt segment body. Alternatively, the first set comprises a single rigid connector with a series of hooks 231 that extend from the belt segment end. The second set of rigid connectors in the fastening system 210 may comprise a series of separately formed rigid connectors 240 with eyelets 241 or a single rigid connector with multiple eyelets.

As shown in FIGS. 10 and 11, to connect a first rigid connector 230 to a second rigid connector 240, the first rigid connector 230 is brought above the second rigid connector 240 so that the hook 231 is above the eyelet 241. Then, the hook 231 is inserted through the eyelet 241 to a hooked position shown in FIG. 11. In the hooked position, the hook 231 and eyelet 241 form laterally-extending load-transferring surfaces to transmit axial tension between the belt segments 203, 204. When hooked, the fingers 237 of the hooking connector 230 overly the raised eyelet horizontal portion 244, the vertical wall 235 of the hook 231 abuts and presses against the outer wall of the eyelet 241 and the curved transition portion 247 of the eyelet connector 240 abuts the 233 upward-slating intermediate portion 233 of the hooking connector. Load transfer occurs between these surfaces during operation of the conveyor belt, during which forces is applied pulling the segments apart. To disconnect the segments, the segments must be pushed together to relieve the axial tension and allow disengagement of the load-transferring surfaces.

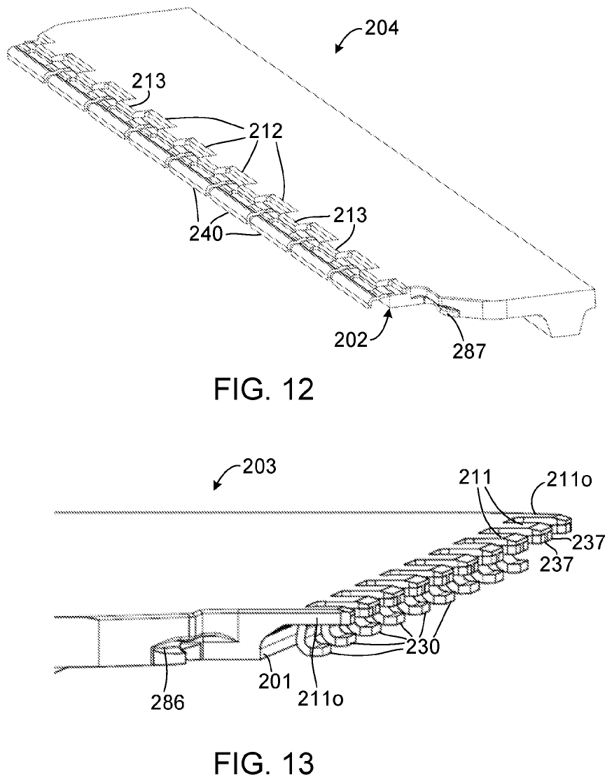

As shown in FIGS. 12 and 13, each mating belt segment 203, 204 includes a series of mating connectors 230, 240 configured to mate with corresponding mating connectors. A portion of each rigid mating connector 230, 240 is embedded within the body of the belt segment and a portion of each rigid connector extends from the body of the belt segment for mating engagement with a corresponding rigid mating connector. The ends 201, 202 of the belt segments 203, 204 may be shaped to interlace or otherwise interface to facilitate the connection. As shown, the illustrative segment 204, which embeds the rigid eyelet connectors 240, includes alternating recesses 212 in the edge corresponding to projections 211 in the mating edge 201 of the corresponding segment 203. The mating edge of the belt segment 204, as shown in FIG. 12, forms overlapping projections 213 between the recesses 212 within which the eyelet connector 240 is embedded. The overlapping projections 213 extend to the eyelet 241 of each eyelet connector 240.

As shown in FIG. 13, the fingers 237 of the rigid hooking connectors 230 are embedded within the projections 211, with the hooks 231 extending down between successive projections 211. Each interior projection 211 embeds two fingers 237 of adjacent rigid hooking connectors 230. The outer projections 2110 are half the width of the inner projections 211 since they embed a single finger 237.

The illustrative configuration of a series of rigid connectors extending from an edge of a conveyor belt segment provides a secure connection between the conveyor belt segments while remaining flexible laterally and longitudinally, so the flexible conveyor belt can form a trough.

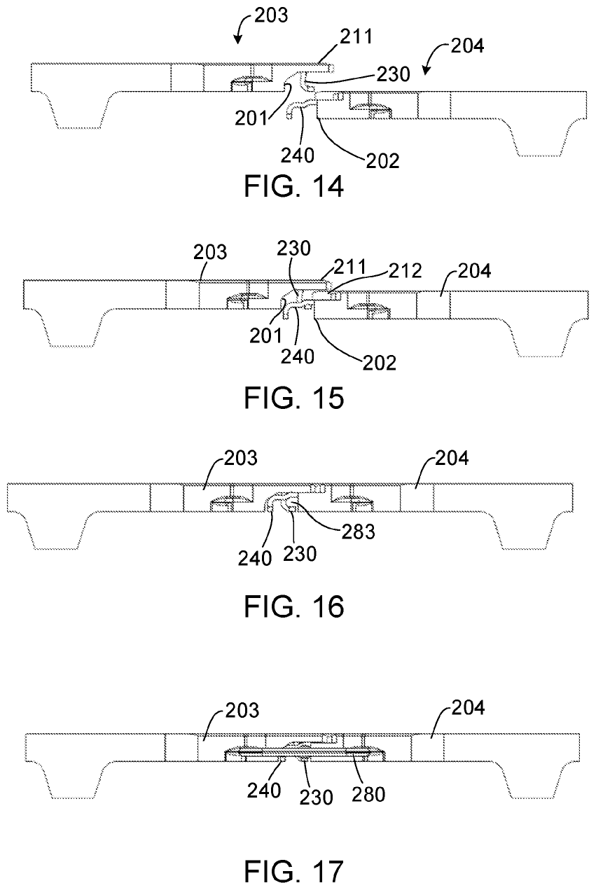

FIGS. 14-17 show the steps involved in mating two belt segments 203, 204 together using rigid connectors 230, 240 anchored in the flexible body of the belt segments. First, as shown in FIG. 14, the mating edge 201 of the hooking belt segment 203 is brought above the mating edge 202 of the eyelet belt segment 204 so that the projections are above the recesses 212 and the hooks 231 are above the eyelets 241. Then, as shown in FIG. 15, the mating edge 201 is lowered into engagement with the mating edge 202, such that the hooks 231 enter the eyelets 241 and projections 211 seat in the recesses 212. In the engaged position, shown in FIG. 16, the top surfaces of the belt segments 203, 204 are flush with each other and the hooks 231 and eyelets 241 are arranged to transfer axial tension between each other when the belt segments are pulled.

In one embodiment, shown in FIGS. 2, 3 and 17, a locking rod 280 may be inserted through a passageway 283 formed by the interlocking hooks and eyelets. The passageway 283 is formed between the hook tip 236, vertical wall 235 and walls 245 and 244 of the eyelet 240 portion.

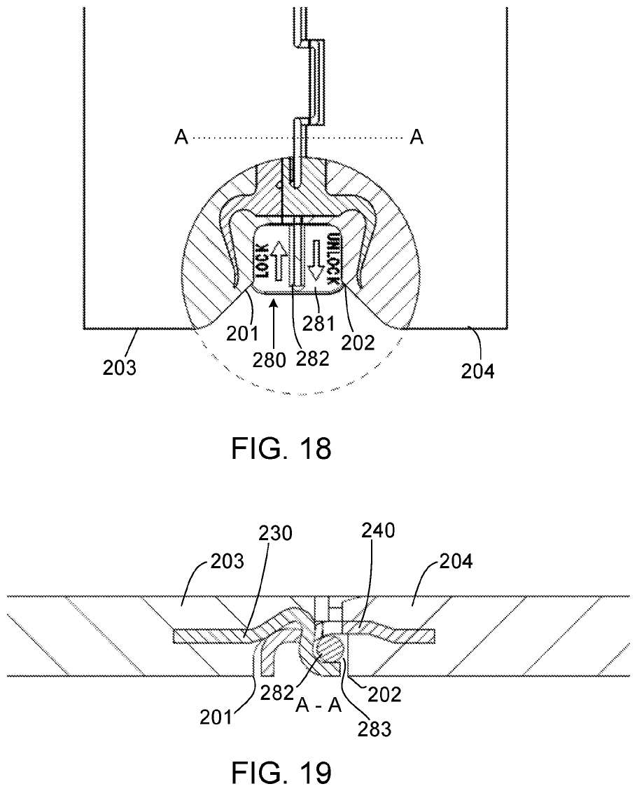

As shown in FIGS. 18 and 19, the locking rod 280 may comprise a head 281 that engages the side edges of the belt segments near the ends 201, 202 and an elongated rod portion 282 that passes through the passageway 283. The rod portion may be flexible to allow troughing of the conveyor belt at the connection point.

The illustrative head 281 includes directional arrows instructing a user how to lock and unlock the fastening system 210.

The edges of the head 281 can fit into locking recesses 286, 287 (shown in FIGS. 5, 12, 13) in the side edges of the conveyor belt segments 203, 204.

As shown in FIGS. 18 and 19, the locking rod 280 may prevent disengagement of the mating connectors 230, 240. The locking rod head 281 sits in a space between the belt segment ends 201, 202, with edges inserted in locking recesses 286, 287. The elongated rod portion 282 extends through the passageway 283 to prevent disengagement of the hook 231 and eyelet 241, while ensuring the tensile forces extend through the rigid connecting elements.

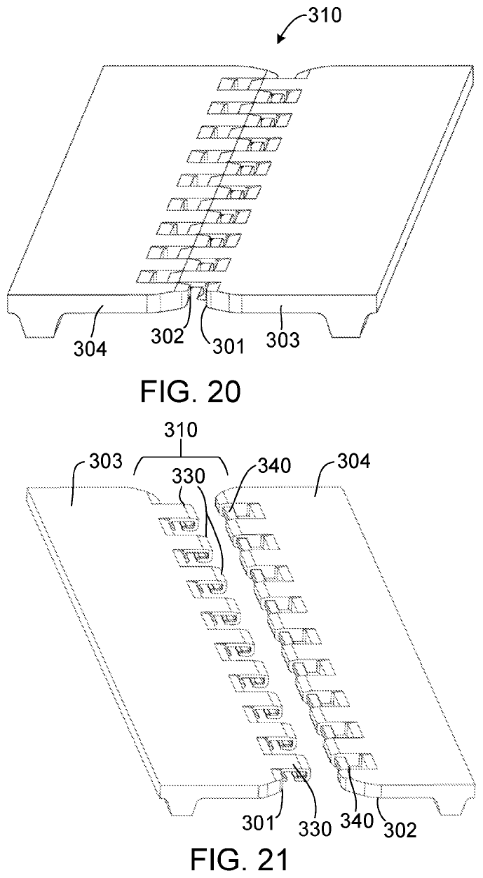

Referring to FIGS. 20-22, in another embodiment, a conveyor belt fastening system 310 includes a first set of laterally spaced apart rigid hooking connectors 330 extending from the inner end 301 of a belt segment 303. The first set of rigid hooking connectors 330 is arranged to mate with a second set of laterally spaced apart rigid eyelet connectors 340 extending from the inner end 302 of the opposing belt segment 304 to join the belt segment ends together.

The illustrative rigid connectors 330, 340 may be anchored in the flexible belt segments 303, 304 through “microscopic entanglement,” as described above, though other suitable means for adhering the rigid connectors to the flexible belt segments may be used, as described above.

FIG. 23 shows an embodiment of a rigid eyelet connector 340 suitable for embedding in a conveyor belt segment to form a fastening system. The rigid eyelet connector 340 comprises a planar base portion 342 configured to be anchored in the body of the conveyor belt segment. Connecting arms 343, 344 extend from side edges of the base 342, with the tips 345, 346 of the connecting arms 343, 344 coiling downwards to form a seat for a laterally-extending bar 347 that together with the arms 343, 344 and base 342 form an eyelet 341. The laterally-extending bar 347 can be integral with the base and arms or a separate component.

As shown in FIG. 24, the rigid hook connector 330 comprises a planar base 332 configured to be anchored in the body of a conveyor belt segment 303. A downward-facing hook 331 extends from the base 332 and comprises a straight protrusion 333 that transitions at the tip to a downward-extending protrusion 334, which transitions to an inward-extending segment 335 that terminates in a downward-slanting edge 336.

As shown in FIG. 25, the hook 331 engages the laterally-extending bar 347 to secure the connectors together. The laterally-extending bar 327 is configured to fit between the bottom surface of the straight protrusion 333, the downward-extending protrusion 334 and inward-extending segment 335, such that load transfer occurs mainly between the downward-extending protrusion 334 and laterally-extending bar 347.

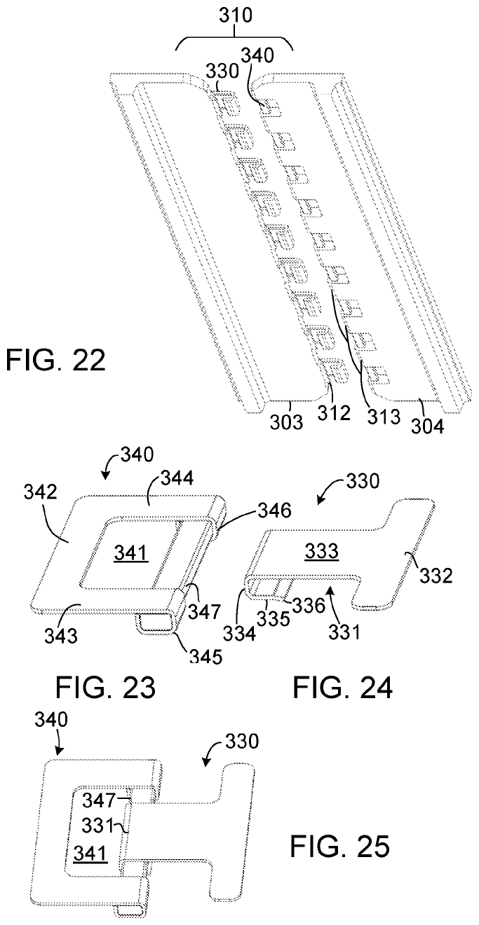

In the illustrative embodiment, the base 342, connecting arms 343, 344 and tips 345, 346 are treated with polymer brushes through the process described above and embedded within the flexible belt segment 304, or otherwise adhered thereto, with the laterally-extending bar protruding from laterally-spaced apart projections 313 on the end 302 of the belt segment 304, as shown in FIG. 22.

In an embodiment, the rigid hook connector 330, the base 332 and outside surfaces of the hook 331 may be treated with polymer brushes through the process described above and embedded within the flexible belt segment 303, or otherwise adhered or fastened thereto, such that the flexible belt segment material covers the outer surfaces of the hook 331, with the rigid inner surface capable of directly engaging the laterally-extending bar 347. Other suitable means for bonding may be used.

The illustrative belt segment 303 includes tapering tabs 312 extending from the connecting end 301 that extend towards the tip 336 of the hook 331. The space between the tapering tabs 312 and tip 336 is slightly larger than the depth of the laterally-extending bar 347 to allow insertion of the laterally-extending bar 347 therebetween.

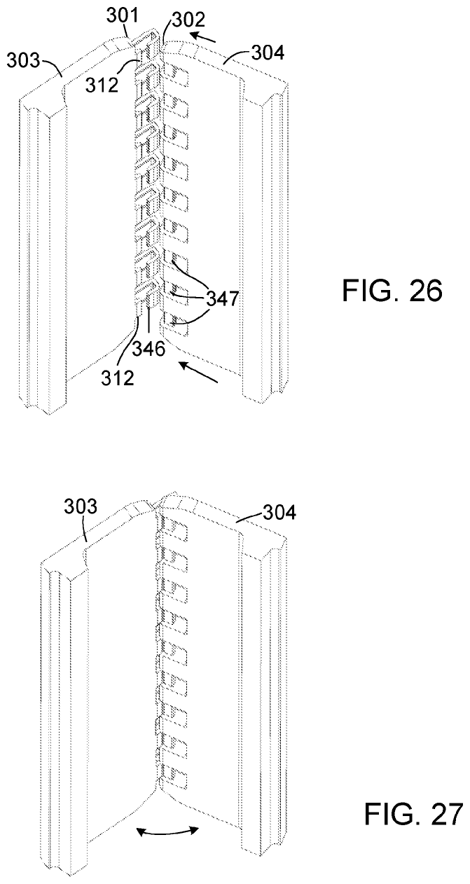

FIGS. 26 and 27 show the steps involved in joining the two flexible conveyor belt segments 303, 304 together. First, as shown in FIG. 26, the segments 303, 304 are angled relative to each other so that the laterally-extending bars 347 face the opening between the hook tip 336 and tapering tab 312 on the flexible segment end 301. Then, the segments 303, 304 are brought close together so that the laterally-extending bars 347 passes between the hook tips 336 and tapering tabs 312. After the laterally-extending bars 347 clears the space between the hook tips 336 and tapering tabs 313, the belt segments 303, 304, are rotated back against each other, as shown in FIG. 27 to pull the laterally-extending bars 347 into engagement with the hooks 331. In the engaged position, the top conveying surfaces of the belt segments 303, 304 are flush with each other, allowing load transfer to occur between the rigid connectors 330, 340.

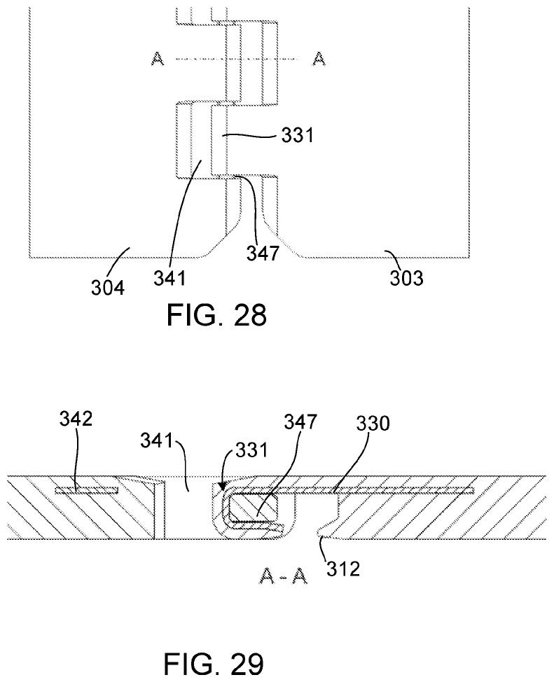

FIGS. 28 and 29 are detailed views of the fastening system in the fastened position. In the fastened position, the hooks 331 engage the laterally-extending bars 347, so that laterally-extending rigid surfaces engage each other to transfer load therebetween.

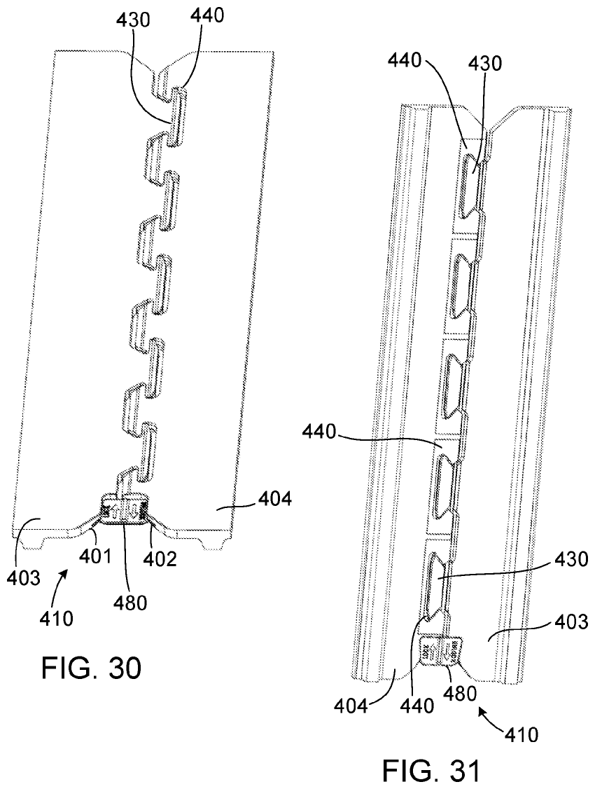

According to another embodiment, shown in FIGS. 30 and 31, a fastening system 410 for a conveyor belt has a puzzle cut pattern, with male and female interlocking portions. A first set of laterally spaced apart rigid connectors 430, comprising shaped projections, extends from the inner end 401 of a flexible belt segment 403. The first set of rigid connectors 430 is arranged to mate with a second set of laterally spaced apart rigid connectors 440 extending from the inner end 402 of the opposing flexible belt segment 404 to join the belt segment ends together. The second set of rigid connectors comprises gaps that are complementary to the shaped projections to allow the ends 401, 402 to mate in a puzzle-like fashion. A locking rod 480 may further secure the connection between the two ends.

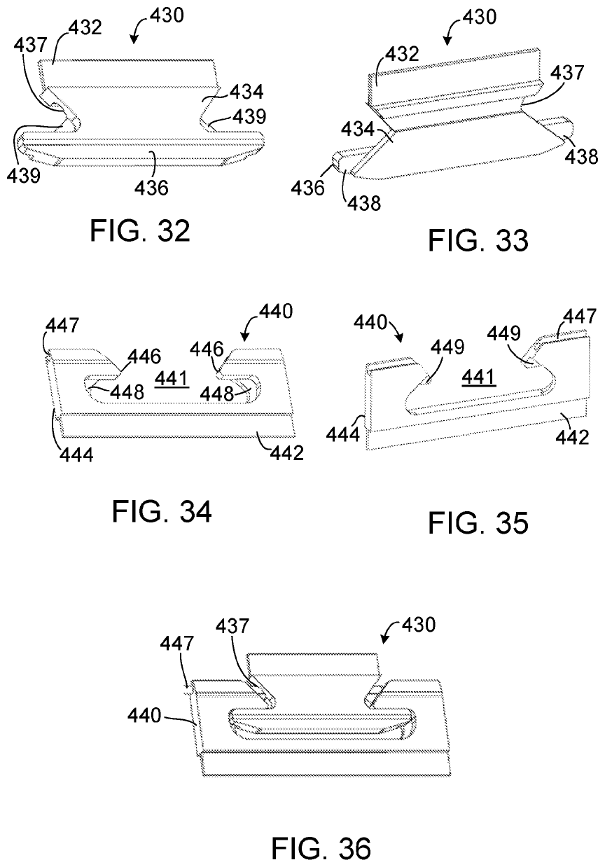

Referring to FIGS. 32 and 33, the illustrative male rigid connectors 430 each comprises a planar base portion 433 configured to be embedded in the end of a flexible conveyor belt segment 403 through microscopic entanglement or another suitable means, as described above. A connecting segment 434 extends from the base portion 432 and tapers in width in an upper portion. A channel 437 extends laterally across the bottom surface of the connecting segment 434 near the base 432. The lower portion of the connecting segment 434 expands in width after the channel 437. A transverse connecting portion 436 forms a connecting end of the connector 430. The transverse connecting portion 436 includes rounded sides and laterally-extending front and rear walls. As shown, the geometry between the transverse connecting portion 436 and connecting segment 434 forms upward-facing crevice shelves 439 between the tapering top portion of the connecting segment and transverse connecting portion and downward-facing tip shelves 438 at the tips of the transverse connecting portion 436.

Referring to FIGS. 34 and 35, the illustrative rigid female connectors 440 each comprises a planar base 443 configured to be embedded in the end of a flexible conveyor belt segment 404 through microscopic entanglement or another suitable means, as described above. A receiving portion 444, which in the illustrative embodiment is also planar and thicker in height than the planar base 443, forms an opening 441 for receiving the connecting segment 434 and transverse connecting portion 446. A transverse rounded channel 447 on the front of the planar base 443 aligns with the channel 437 on the male connector 430 when the male and female connectors are engaged. The opening 441 includes confronting tips 446 forming shelves 449 on an underside for interfacing with the crevice shelves 439 and tip shelves 448 for interfacing with the tip shelves 438 of the male connector 430.

Additional mating tabs and crevices may be used in the connectors 430, 440 to prevent rotation of the connectors relative to each other.

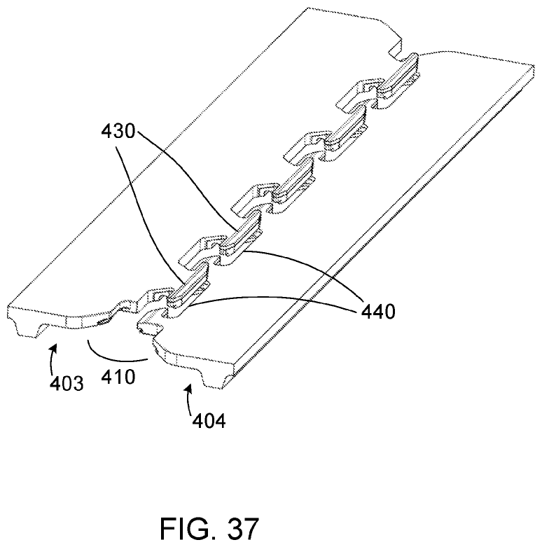

FIG. 36 shows the insertion of a rigid male connector 430 into a rigid female connector 440 according to an embodiment. FIG. 37 shows a flexible conveyor belt segment 403 including a series of rigid male connectors 430 during fastening to a corresponding flexible conveyor belt segment 404 including a series of rigid female connectors 440 configured to receive the rigid male connectors 430. When engaged, the channels 437, 447 align and the transversely-extending rear wall of the transverse connecting portion 436 abuts laterally-extending walls of the opening 441.

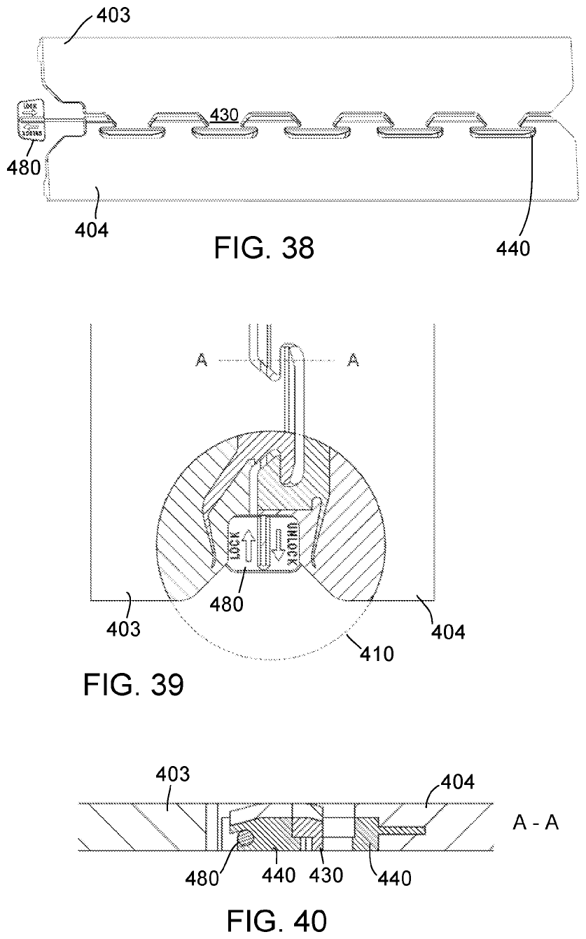

As shown in FIG. 38, after a set of rigid male connectors 430 extending from a first end of a belt segment 403 is inserted in a set of rigid female connectors 440, a locking rod 480 may be inserted into the aligned channels 437, 447 to retain the connectors in the engaged position.

FIG. 39 shows the edge of the fastening assembly 410 in an assembled position. FIG. 40 is a cross-sectional view through line A-A of FIG. 39. As shown, the top surfaces of the male connectors 430, female connectors 440 and belt segments 403, 404 are flush with each other, as are the bottom surfaces.

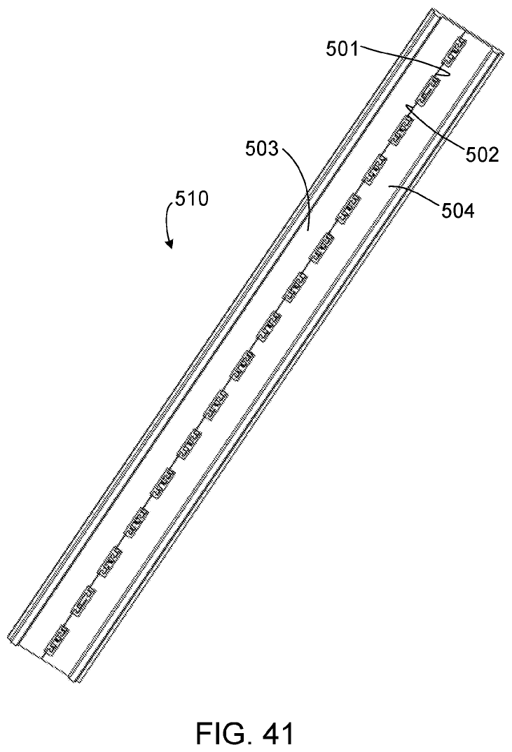

FIG. 41 shows another embodiment of a fastening assembly 510 for a conveyor belt comprising mating rigid connectors embedded in and extending from flexible belt segments. The fastening assembly 510 comprises alternating sets of laterally spaced apart rigid hooking connectors comprising lateral hooks extending from the inner end 501, 502 of opposing belt segments 503, 504. While each illustrative hooking connector comprises a pair of laterally extending hooks with a containment feature or latch in between extending from a unitary base, alternatively, individual components of the rigid mating connectors may be separately embedded in and extend from the flexible belt segment. The individual components may be laterally spaced from each other within the flexible belt segment to form a similar configuration as shown.

The illustrative rigid connectors may be anchored in the flexible belt segments 303, 304 through “microscopic entanglement,” as described above, though other suitable means for adhering the rigid connectors to the flexible belt segments may be used, as described above.

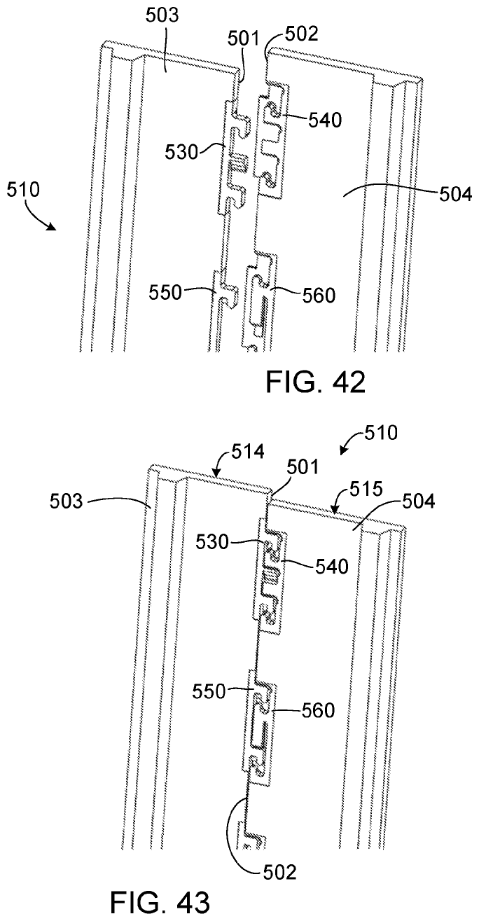

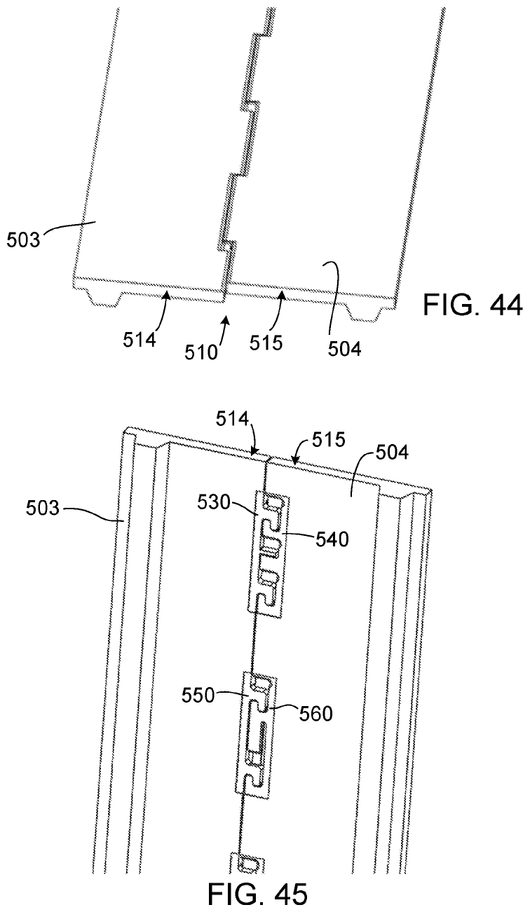

Referring to FIG. 42, the fastening system 510 is assembled by bringing first, second third and fourth rigid hooking connectors 530, 540, 550, 560 near each other. Then, as shown in FIG. 43, the rigid hooking connectors 530, 540, 550, 560 slide into engagement, such that laterally-extending hooks (as described below) interface each other. In this position, the edges 514, 515 of the belt segments 503, 504 are unaligned relative to each other, as also shown in FIG. 44.

Then, as shown in FIG. 45, the belt segments 503, 504 shift relative to each other to slide the rigid hooking connectors 530, 540, 550, 560 into engagement, securing the belt segments 503, 504 together. In this position, the edges 514, 514 align, though the invention is not so limited to alignment between the edges.

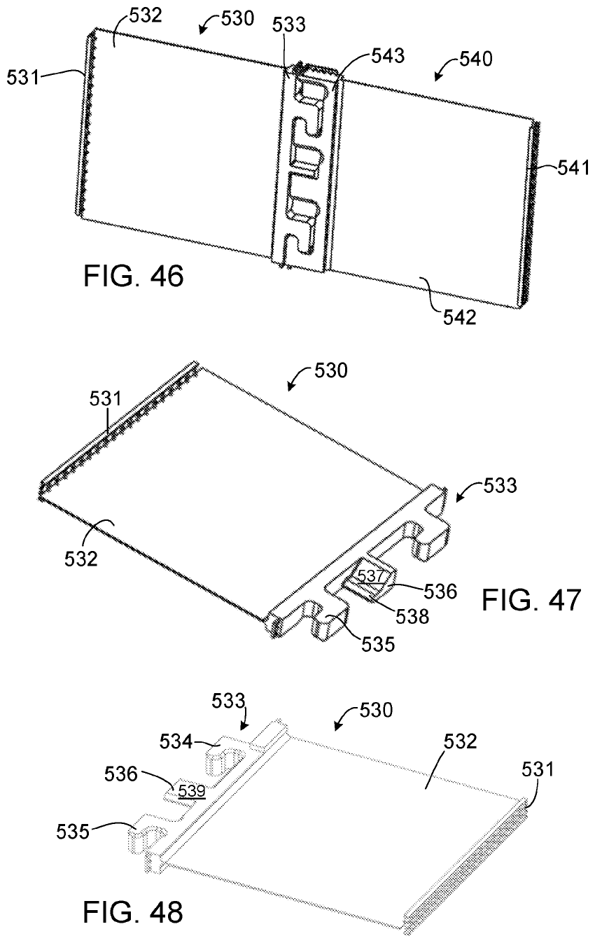

FIG. 46 is a detailed view of a first set of rigid hooking connectors 530, 540 embedded in a flexible belt segment and configured to engage each other. Each rigid hooking connector 530, 540 includes an anchor portion 531, 541, respectively, a planar base portion 532, 542, respectively and mating portions 533, 543.

Referring to FIGS. 47 and 48, an illustrative first rigid hooking connector 530 includes an anchor 531, which comprises a lattice extending above and below the planar base portion 532 perpendicular to the planar base portion for anchoring the first rigid hooking connector 530 within an associated flexible belt segment 503. The planar base portion 532 extends to the mating portion 533, which also extends above and below the planar base portion 532. The mating portion 533, which protrudes from the end of the flexible belt segment 503, while the anchor 531 and planar base portion 532 are embedded therein, comprises first and second L-shaped lateral hooks 534, 535, each comprising a first protrusion extending longitudinally and a tip extending laterally and forming a lateral load-transferring surface. A containment tab 536 extends between the lateral hooks 534, 535 and comprises a flat bottom surface that transitions to a sloping surface 537 and a lateral tab 538. The top of the containment tab 535 is a flat surface 539.

To embed the first rigid hooking connector 530 within a flexible belt segment 503, microscopic entanglement may be used, as described above. In another embodiment, the flexible belt segment 503 may be injection molded directly around the rigid hooking connectors, with the lattice in the anchor 531 allowing molten plastic to pass through the lattice and around the base portion, creating an anchor for the connector. Small or microscopic undercuts may be added to the adhering surfaces of the connector 530 using sand blasting or another finishing technique to facilitate connection to the plastic in the flexible belt segment. In addition, the planar base portion 532 may include openings to allow molten plastic to pass therethrough to facilitate embedding of the connector 530 within the body of the flexible belt segment 503. The flexible belt segment 503 is molded such that the lateral hooks 534, 535 and containment tab 536 protrude from the body of the segment.

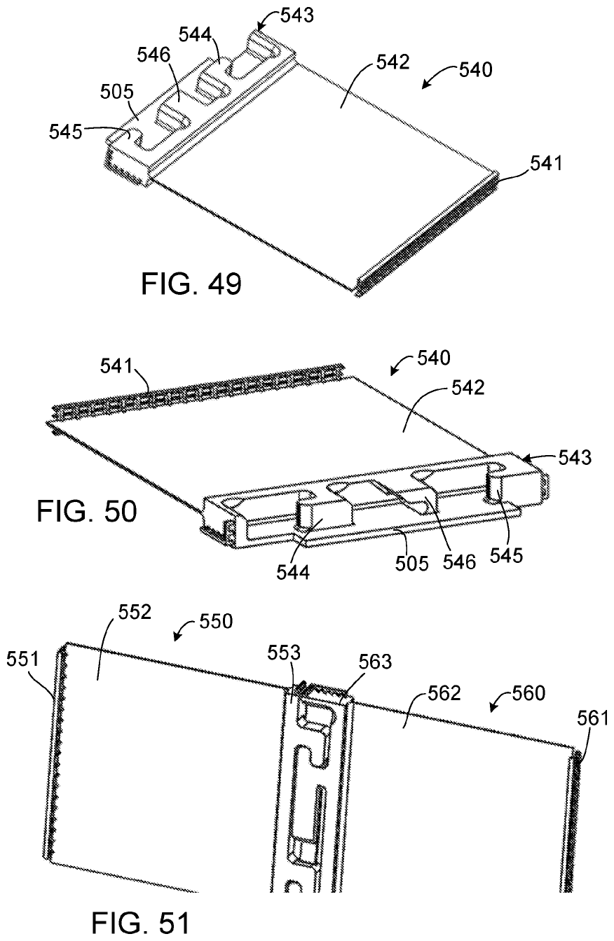

Referring to FIGS. 49 and 50, the second rigid hooking connector 540 comprises an anchor 541, comprising a lattice extending above and below and perpendicular to the planar base portion 542 and a mating portion 543 configured to mate with the mating portion of the first rigid hooking connector 530. The illustrative mating portion 543 includes a hood 505 configured to be flush with the conveying surface formed by the flexible belt segments for covering the mating elements of the connectors. First and second L-shaped lateral hooks 544, 545 are configured to mate with the lateral hooks 534, 535 of the first rigid hooking connector and are connected to the hood 505. A containment tab seat 546 is formed between the lateral hooks 544, 545 for receiving the containment 536. As the lateral hooks 534, 535, 544, 545 slide into engagement with each other, the containment tab seat 546 receives and locks onto the containment 536 to prevent vertical separation of the hooks and—or rotation of the belt ends relative to each other.

The second rigid hooking connector 540 may be embedded in an associated flexible belt segment 504 in the same or similar way as the first rigid hooking connector 530 is embedded in the associated flexible belt segment 503, as described above.

The lateral hooks 534, 535, 544 and 545 are configured such that the lateral shift between the hooks while mating is less than the width of the overlapping hood 505, so that the top cover surface is maximized, promoting a continuous conveying surface.

Referring to FIGS. 51-54, a second set of rigid hooking connectors 550, 560 is laterally spaced from the first set of rigid hooking connectors 530, 540. The fastening system 510 may comprises multiple sets of rigid hooking connectors arranged along the fastening ends of the belt segments 503, 504. The rigid hooking connectors 550, 560 are also embedded in a flexible belt segment and configured to engage each other. Each rigid hooking connector 550, 560 includes an anchor portion 551, 561, respectively, a planar base portion 552, 562, respectively and mating portions 553, 563.

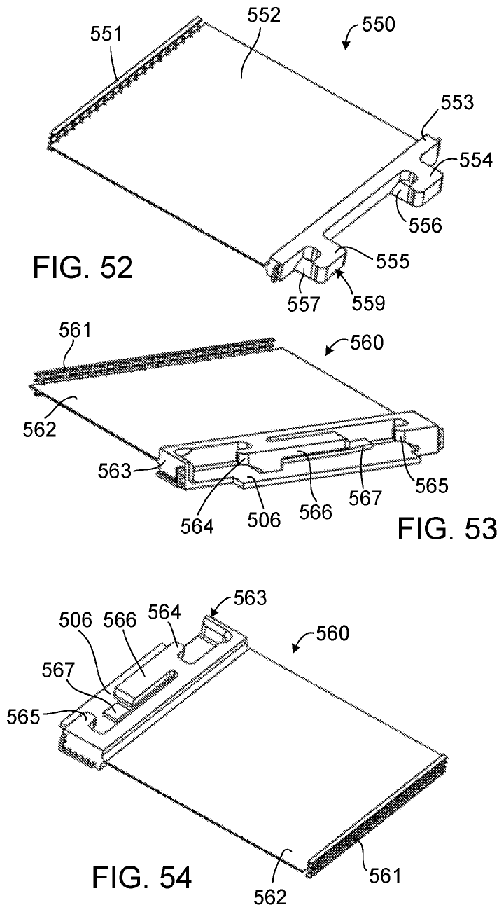

As shown in FIG. 52, the third rigid hooking connector 550 comprises an anchor 551, which comprises a lattice extending above and below and perpendicular to the planar base portion 552 for anchoring the third rigid hooking connector 550 within an associated flexible belt segment 503. The planar base portion 552 extends to the mating portion 553, which also extends above and below the planar base portion 552. The mating portion 553, which protrudes from the end of the flexible belt segment 503, while the anchor 551 and planar base portion 552 are embedded therein, comprises first and second L-shaped lateral hooks 554, 555, each comprising a first protrusion extending longitudinally and a tip extending laterally and forming a lateral load-transferring surface. A sloping transition surface 556, 557 extends between the first protrusion and tip. In one embodiment, the top of the hook 554 appears square or rectangular and the second hook 555 has a notch 559 on a top surface to form a seat for a latching spring in the fourth rigid hooking connector, as described below.

The fourth rigid hooking connector 560, which is configured to mate with the third rigid hooking connector 550 and extend from the second flexible belt segment 504, spaced laterally from a second rigid hooking connector, as shown in FIGS. 42 and 43, is shown in detail in FIGS. 53 and 54. The fourth rigid hooking connector 560 includes a hood 506 configured to be flush with the conveying surface formed by the flexible belt segments for covering the mating elements of the connectors 550, 560. Lateral tips 564, 565 are configured to mate with the lateral hooks 554, 555 of the third rigid hooking connector. As shown in FIG. 53, the lateral tips 564, 565 have angled bottom surfaces configured to interface the sloping transition surfaces 556, 557. A cantilever leaf spring, comprising a lateral latching protrusion 566 and thinner leaf spring 567, extends between the lateral tips 564, 565 and is connected to the first lateral tip 564. The leaf spring 567 has a slightly bent end. Any type of cantilever leaf spring may be used. To connect the third and fourth rigid hooking connectors, the lateral hooks 554, 555 are inserted into corresponding spaces in the mating end 563, which depresses the leaf spring 567, then shifted to engage the lateral hooks 554, 555 with the lateral tips 564, 565. After the hook 555 clears the leaf spring 567, it springs back and pushes against a longitudinal surface of the lateral hook 555 to latch the connectors 550, 560 together with a compressive force. The notch 559 may contain the tip of the leaf spring 567. The lateral shifting of the hooks is larger than the clearance between the leaf spring tip and the hook 555. The leaf spring 567 can be depressed to allow the rigid hooking connectors to slide out of engagement with each other to separate the flexible belt segments, if desired.

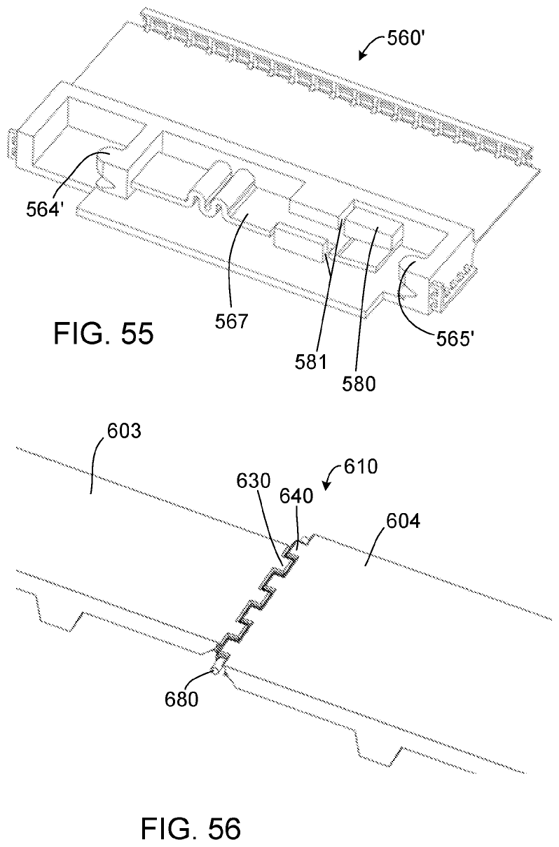

FIG. 55 shows an alternative embodiment of an alternate rigid hooking connector 560′ configured to mate with a third rigid hooking connector 550. The alternate rigid hooking connector 560′ includes lateral hooks 564′, 565′ configured to engage lateral hooks 554, 555 of a corresponding rigid hooking connector 550 and a latching section including an s-shaped leaf spring 567. As the lateral hook 555 clears the lateral hook 565′, it latches into place, pushing against a block 580 formed at the end of the s-shaped leaf spring 567 until the block abuts stopping faces 581, creating a strong latch. In the illustrative embodiment, the amount of lateral shift of the hooks relative to each other is significantly larger than the amount of movement in the latching leaf spring. The latch can be released to allow separation of the hooking connectors and opening of the conveyor belt.

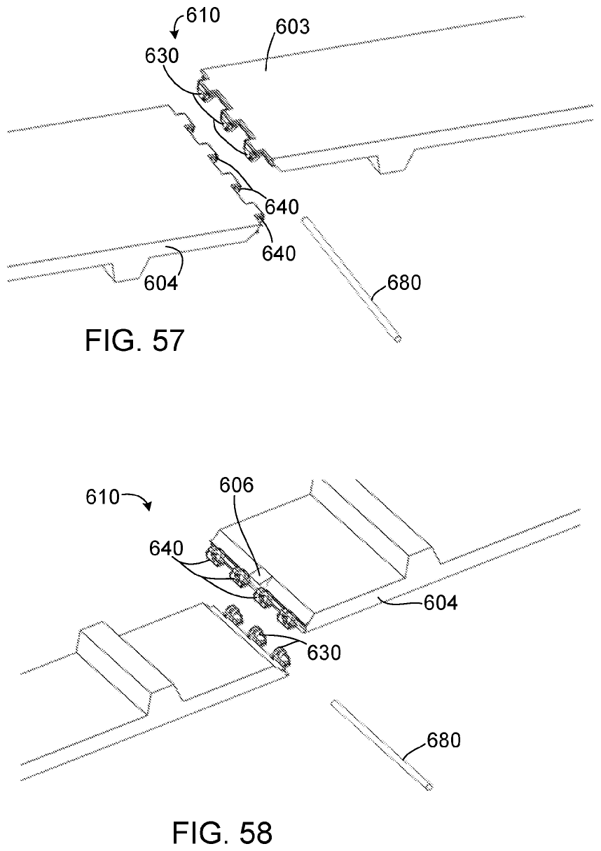

FIG. 56-58 show another embodiment of a fastening assembly 610 for a conveyor belt comprising rigid connectors extending from flexible belt segments. The fastening assembly comprises a plurality of rigid connecting segments 630, 640 embedded in and extending from mating ends of flexible conveyor belt segments 603, 604. A connecting rod 680 secures the connection between the rigid connecting segments 630, 640. The fastening assembly 610 may also include a bottom protrusion 606 on a chamfered surface at the end of the flexible belt segment 604 to minimize hinging and prevent over-rotation of the segment ends relative to each other.

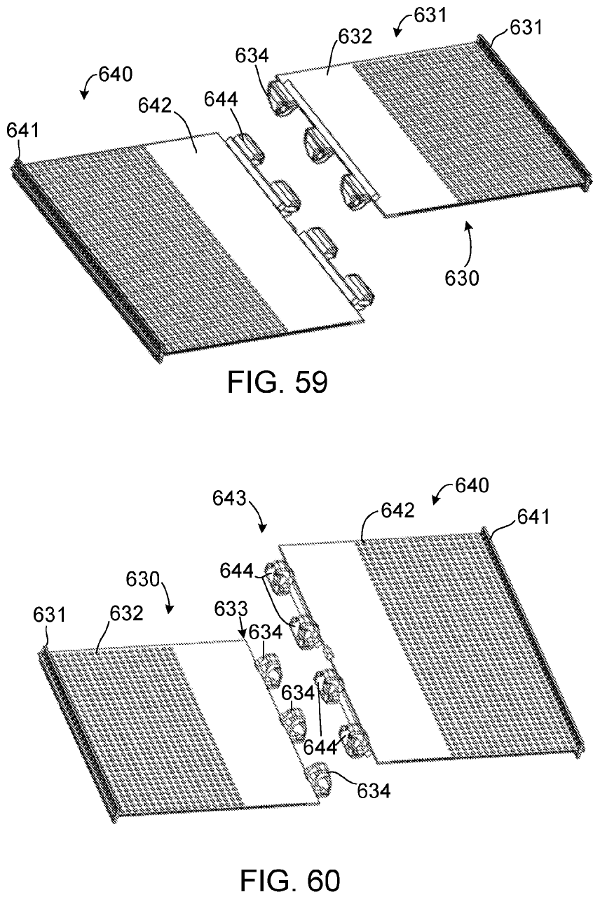

Referring to FIGS. 59 and 60, each illustrative rigid connector 630, 640 includes an anchor 631, 641, which comprises a lattice extending above and below and perpendicular to a planar base portion 632, 642, for anchoring each respective rigid hooking connector 630, 640 within an associated flexible belt segment 603, 604. The illustrative planar base portions 632, 642 have a mesh portion, comprising a pattern of openings. The planar base portions 632, 642 also have a solid portion, but the invention is not so limited, and a base portion can have any suitable configuration. Mating portions 633, 643 extend from the inner ends of the base portions and above and below the planar base portions 632, 642, which, along with the anchors 631, 641 are embedded within the flexible belt segment. Each mating portion 633, 643 comprises an array of laterally spaced apart hinge elements 634, 644 having aligned hinge openings for receiving the connecting rod 680. The hinge elements interleave to form a hinge passageway for receiving the connecting rod 680.

Each rigid connector 630, 640 may be formed of a metal or rigid plastic, then embedded in a flexible belt segment 603, 604 by injection molding the flexible belt segment around the rigid connector so that the hinge elements 634, 644 extend from the end of the flexible belt segment while the base portions and anchor are embedded within the belt segment. Other suitable manufacturing means may be used. Small or microscopic undercuts may be added to the adhering surfaces of the connectors 630, 640 using sand blasting or another finishing technique to facilitate connection to the flexible belt segment. The use of the planar base portion and anchor allows transmission of belt pull away from the connecting portions.

In one embodiment, the rigid connectors may be embedded within a separate or intermediate belt segment adapted to be spliced or otherwise connected to an end of a conveyor belt segment. Alternatively, rigid connectors may be embedded directly on an end of a conveyor belt. In another embodiment, a conveyor belt may be formed by joining a series of flexible conveyor belt segments with embedded rigid connectors extending from each end in a modular format.

In still another embodiment, a conveyor component may comprise rigid connectors embedded in a flexible portion through a chemical and—or microscopic entanglement process described above. For example, a two-piece sprocket or roller may comprise rigid connectors that extend from injected molded bodies that mate to form the sprocket or roller, where the rigid connectors adhere to the injection molded bodies through polymer brushes to create a chemical bond, microscopic entanglement or a combination or both in a process such as that described above.

The scope of the claims is not meant to be limited to the details of the described exemplary embodiments.

What is claimed is:

1. A fastening system for fastening a first end of a flexible conveyor belt segment to a second end of a flexible conveyor belt segment, comprising:
a first rigid connector extending from the first end, the first rigid connector comprising a base embedded in the first end and a connecting portion, the connecting portion including a first laterally-extending load-transferring surface;
a second rigid connector extending from the second end, the second rigid connector comprising a base embedded in the second end and a connecting portion comprising a second laterally-extending load-transferring surface configured to interface with the first laterally-extending load-transferring surface.

2. The fastening system of claim 1, further comprising a locking rod for locking the first and second laterally-extending load-transferring surfaces in an engaged position.

3. The fastening system of claim 1, wherein the first end and the second end are shaped to interlace with each other.

4. The fastening system of claim 1, wherein the first rigid connector and second rigid connector comprises one of stainless steel, titanium, glass fiber, carbon fiber, nylon, and combinations thereof.

5. The fastening system of claim 1, wherein the first and second belt segments comprise injection molded plastic over molded onto polymer brushes formed on the first and second rigid connectors.

6. The fastening system of claim 1, wherein the first rigid connector comprises a hook and the second mating connector comprises an eyelet configured to receive the hook.

7. The fastening system of claim 6, wherein the connecting portion of the hook comprises a downward extending hook comprising a first upward extending intermediate portion extending from the base portion, an upper curve, a downward-extending straight portion forming the load-transferring surface and a curved tip extending away from the base portion.

8. The fastening system of claim 7, wherein the first rigid connector further comprises fingers separated from the hook by spaces.

9. The fastening system of claim 6, wherein the connecting portion of the second rigid connector includes an eyelet portion extending from the base, the eyelet portion including an opening configured to receive the hook of a first rigid connector, wherein the eyelet portion comprises an upward slanted portion, a horizontal planar portion that is parallel to the base, a downward slanted portion extending away from the base and a downward extending segment connected to the downward slanted portion via a curved transition portion.

10. The fastening system of claim 6, wherein the hook comprises a straight protrusion extending from the base that transitions to a downward-extending protrusion, which transitions to an inward-extending segment that terminates in a downward-slanting edge to form the hook.

11. The fastening system of claim 10, wherein the eyelet comprises connecting arms extending from side edges of the base, the connecting arms including tips that coil downwards to form a seat for a laterally-extending bar for engaging the hook.

12. The fastening system of claim 1, wherein the connecting portion of the first rigid connector comprises a shaped projection and the connecting portion of the second rigid connector comprises an opening for receiving the shaped projection in a puzzle-like fashion.

13. The fastening system of claim 12, wherein the shaped projection comprises a connecting segment extending from the base and a transverse connecting portion having rounded sides and a laterally-extending rear wall forming the load-transferring surface.

14. The fastening system of claim 1, wherein the connecting portion of the first rigid connector comprises first and second lateral hooks configured to slide into engagement with third and fourth lateral hooks forming the connecting portion of the second rigid connector.

15. The fastening system of claim 14, further comprising a latch for securing the first rigid connector and the second rigid connector to each other.

16. The fastening system of claim 1, further comprising an anchor connected to the base of the first rigid connector and embedded with the first end of the flexible conveyor belt segment for anchoring the first rigid connector to the flexible conveyor belt segment.

17. The fastening system of claim 16, wherein the anchor comprises a lattice extending perpendicular to the base.

18. A conveyor belt segment, comprising:
a flexible body extending in thickness from a top surface to a bottom surface, in width from a first side to a second side and in length from a first end to a second end;
a first rigid connector extending from the first end, the first rigid connector comprising a base embedded in the flexible body and a connecting portion protruding from the first end.

19. The conveyor belt segment of claim 18, wherein the connecting portion comprises a laterally-extending load transferring surface.

20. The conveyor belt segment of claim 19, wherein the first rigid connector comprises a hook.

21. The conveyor belt segment of claim 20, wherein the hook is a downward extending hook comprising a first upward extending intermediate portion extending from the base, an upper curve, a downward-extending straight portion forming the load-transferring surface and a curved tip extending away from the base.

22. The conveyor belt segment of claim 19, wherein the hook comprises a straight protrusion extending from the base that transitions to a downward-extending protrusion, which transitions to an inward-extending segment that terminates in a downward-slanting edge to form the hook.

23. The conveyor belt segment of claim 18, wherein the connecting portion comprises an eyelet.

24. The conveyor belt segment of claim 18, wherein the connecting portion comprises a shaped projection having a connecting segment extending from the base and a transverse connecting portion having rounded sides and a laterally-extending rear wall forming a load-transferring surface.

25. The conveyor belt segment of claim 18, wherein the connecting portion comprises first and second lateral hooks.

26. The conveyor belt segment of claim 25, further comprising a latch between the first and second lateral hooks.

27. The conveyor belt segment of claim 18, wherein the connecting portion comprises a series of laterally-spaced apart hinge elements having aligned hinge openings.

28. The conveyor belt segment of claim 18, further comprising an anchor connected to the base and embedded with flexible body of the flexible conveyor belt segment for anchoring the first rigid connector to the flexible body.

29. The conveyor belt segment of claim 28, wherein the anchor comprises a lattice extending perpendicular to the base.

30. The conveyor belt segment of claim 18, wherein the base comprises a planar portion having a pattern of openings.

31. A conveyor belt segment configured to mate with another conveyor belt segment, comprising:
a flexible body having a top conveying surface and a bottom surface including drive structure, the flexible body extending in length from a first end to a second end and in width from a first side to a second side; and
a first set of laterally spaced apart rigid connectors extending from the first end of the flexible body, each rigid connector including a base embedded in the flexible body through microscopic entanglement and a connecting portion extending from the first end.

32. The conveyor belt segment of claim 31, wherein the connecting portion comprises one of a hook, an eyelet, a shaped protrusion, a shaped recess, and a hinge element.
